(19) United States
(12) Patent Application Publication
(10) Pub. No.: US 2015/0206198 A1
(43) Pub. Date: Jul. 23, 2015

(54) Method and System to Generate Digitized Advertisement Content by Extraction from a Representation of a Completed Instantiation of a Rendered Webpage

(71) Applicant: JOHN BURNET MARSHALL, SANTA CRUZ, CA (US)

(72) Inventor: JOHN BURNET MARSHALL, SANTA CRUZ, CA (US)

(21) Appl. No.: 14/585,630

(22) Filed: Dec. 30, 2014

Related U.S. Application Data
(63) Continuation-in-part of application No. 61/921,889, filed on Dec. 30, 2013.

(51) Int. Cl. G06Q 30/02; G06F 17/22

(52) U.S. Cl. CPC G06Q 30/0276; G06F 17/2247

(57) ABSTRACT

Methods, systems and software-encoded instructions enable a computer to automatically generate a full representation of a visual rendering of a webpage in its entirety and as it would be experienced by a human user. A time delay may be imposed to enable a web browser to better simulate a dynamic presentation of a visually displayed rendering of the webpage. Individuated elements of content are evaluated and ranked according to specified criteria and/or relative visual aspects of each element within the full context of the representation, including size, localized contrast, screen position, and proximity to other visually prominent content elements. User interaction with the representation may be emulated to further enable a simulation of a user experience of an initial visual rendering of the webpage that could be derived from the representation.

### CONTINUATION-IN-PART APPLICATION

The present application is a Continuation-in-Part Application of U.S. Provisional Patent Application Ser. No. 61/921,889 filed on Dec. 30, 2013 and titled “Mimicking human perception to determine the important elements of a webpage”, wherein the present application claims benefit of the priority date of the filing of U.S. Provisional Patent Application Ser. No. 61/921,889 filed on Dec. 30, 2013. Furthermore, the U.S. Provisional Patent Application Ser. No. filed on Dec. 30, 2013 and titled “Mimicking human perception to determine the important elements of a webpage”, is incorporated within the present application in its entirety and for all purposes.

### FIELD OF THE INVENTION

The present invention relates to the extraction of information from webpage software for use in digitized images, such as announcements related to the content of the source webpage software. More particularly, the present invention relates populating software documents, such as advertisements, with content provided for use in a dynamic rendering of a webpage.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art provides methods for automatically selecting content for inclusion in an advertisement for a webpage by detecting and evaluating content of the webpage itself. The prior art evaluations are made on the basis of evaluating certain instructions and parameters provided software code that is to be executed to visually render the webpage of interest. The prior art, however, fails to optimally simulate the selected webpage as the rendered webpage would be dynamically experienced by a human user in the process of evaluating and selecting webpage content for inclusion in a referencing or related advertisement or other announcement of information. The prior art fails to optimally consider several increasingly common aspects of webpage rendering that affect a user experience of a human viewer of a webpage, including (a.) the user's gestalt perception of various visual elements of a webpage in the visual context presented only after the webpage is fully rendered; (b.) the dynamic morphing of visual elements that occur in an initial completion of a fully rendered webpage; (c.) sourcing rendered information from more than one source, wherein the additional content may optionally by revised without indication within the webpage formatting code; (c.) the effect of human viewer user initial interaction with a webpage, such as scrolling commands or closing pop-up windows selections entered by a human viewer of a webpage; and (d.) other aspects of human experience of rendered webpages that are known in the art and are not reliably evaluated by a static analysis of software code used to direct a computational device to render a webpage that is at least partially derived from the analyzed.

There is, therefore, a long-felt need to provide more optimal methods of detecting, evaluating and selecting content from an intended webpage rendering in a process that presents a more accurate simulation of a dynamic human viewer user experience of a visual rendering of the selected webpage in view of a totality of the instructions and information provided to a web browser for application in a dynamic rendering of webpage content.

### SUMMARY AND OBJECTS OF THE INVENTION

Towards these objects and other objects that will be made obvious in light of the present disclosure, a system and method are provided that comprise the generation of a representation of a rendered webpage within a computational system and the evaluation and selective extraction of information from the representation of the rendered webpage (hereinafter, the “representation”) wherein the information is made available for inclusion in an resultant document. The resultant document is preferably adapted for rendering by a web browser and may comprise or provide a digitized advertisement document (hereinafter, “advertisement”).

The method of the present invention (hereinafter, “the invented method”) a software code adapted to enable a web browser to render an entire webpage is received or accessed by a computer. The computer derives a representation of a visual rendering of the entire webpage. Optionally, content from more than one source may be received or accessed to form the representation.

In one optional aspect of the invented method, the software code is downloaded or accessed by the computer in more than one discrete communications exchange. In another optional aspect of the invented method, the computer messages a remote computer, storage device or webserver to a request a download of, or otherwise enable access to, the software code in in one or more sessions or separate interactions. Yet another optional aspect of the invented method, the computer messages an additional computer, storage device or webserver to a request a download, or to enable access to, additional content that may be combined with the software code in a generation of the representation by the computer.

In an additional optional aspect of the invented method, the computer may emulate one or more human viewer user interactions with the representation prior to evaluation of the content of the representation. The emulated human viewer user interaction may include, but is not limited to, an emulation of (a.) a command to close a pop-up window; (b.) an instruction to scroll; (c.) an input of a menu selection; and/or (d.) other suitable webpage interaction user commands known in the art.

The evaluation of content of the invented method may include an evaluation of a meaning and relative visual prominence of detected content of the webpage as would be instantiated in a visual display of a rendering of the webpage according to an analysis of the representation. The factors considered optionally applied to evaluate individuated element of content of the representation include, but are not limited to, (a.) semantic value; (b.) font size of a textual component of the element; (c.) relative size of a textual component of the element; (d.) local contrast of text or imagery of the element with its immediate background; (e.) relative screen position as indicated within the representation; and (f.) an indicated screen proximity of the element to one or more other content elements as indicated by the representation.

A still other optional aspect of the invented method includes a generation of a ranking of content elements of the webpage in accordance with the representation, wherein elements of a higher rank are selected for inclusion in the advertisement or other resultant document. A yet additional optional aspect of the invented method includes an inclusion of a hyperlink in the advertisement or resultant document, wherein the hyperlink may specify a universal resource locator of or related to the webpage.

This Summary is provided to introduce a selection of concepts in a simplified form that are further described below in the Detailed Description. This Summary is not intended to identify key features or essential features of the claimed subject matter, nor is this Summary intended to be used to limit the scope of the claimed subject matter.

### BRIEF DESCRIPTION OF FIGURES

These, and further features of the invention, may be better understood with reference to the accompanying specification and drawings depicting the preferred embodiment, in which:

FIG. 1 is an illustration of a rendering of a compete webpage by a web browser as directed by a software encoded representation of the webpage;

FIG. 2 is a block diagram of an electronic communications network, comprising a computational device, a webserver, a first alternate content source and a second alternate content source that are each bi-directionally coupled by means of the Internet;

FIG. 3 is flowchart of a prior art process of the computational device of FIG. 2 in cooperation with the electronic communications network of FIG. 2 wherein software encoded webpage content of FIG. 1 is attempted to be automatically evaluated, scored and extracted from a webpage code of FIG. 2 and then inserted into an advertisement document;

FIG. 4 is a block diagram of the computational device of FIG. 2;

FIG. 5 is a flowchart of aspects of the invented method whereby the computational device populates an advertisement from elements of a simulated representation of a visually rendered webpage;

FIG. 6 is a flowchart of an optional extension of the invented method as presented in FIG. 5, whereby the computational device of FIG. 2 emulates exemplary human viewer user interactions;

FIG. 7 is a flowchart of an additional optional extension of the invented method as presented in FIG. 5, whereby the computational device of FIG. 2 emulates exemplary human viewer user interactions;

FIG. 8 is a flowchart of a method of inserting a time delay in a wait state as optionally applied in the processes of FIGS. 6, 7 and 8, wherein a representation of a webpage rendering of FIG. 4 is further developed to better simulate a user view of the webpage of FIG. 1;

FIG. 9 is a flowchart of a further optional aspects of the invented method, whereby the computational device of FIG. 2 assigns numerical scores to elements of a representation of the rendered webpage code of FIG. 2;

FIG. 10 is a block diagram of an exemplary advertisement as generated by the methods of FIG. 5 through FIG. 9;

FIG. 11 is an illustration a rendering by the network device of FIG. 2 of the advertisement of FIG. 10 as generated by the methods of FIG. 5 through FIG. 9; and

FIG. 12 is a flowchart of operations of the network device of FIG. 2 whereby the advertisement of FIG. 10 renders the display image of FIG. 11.

The Figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

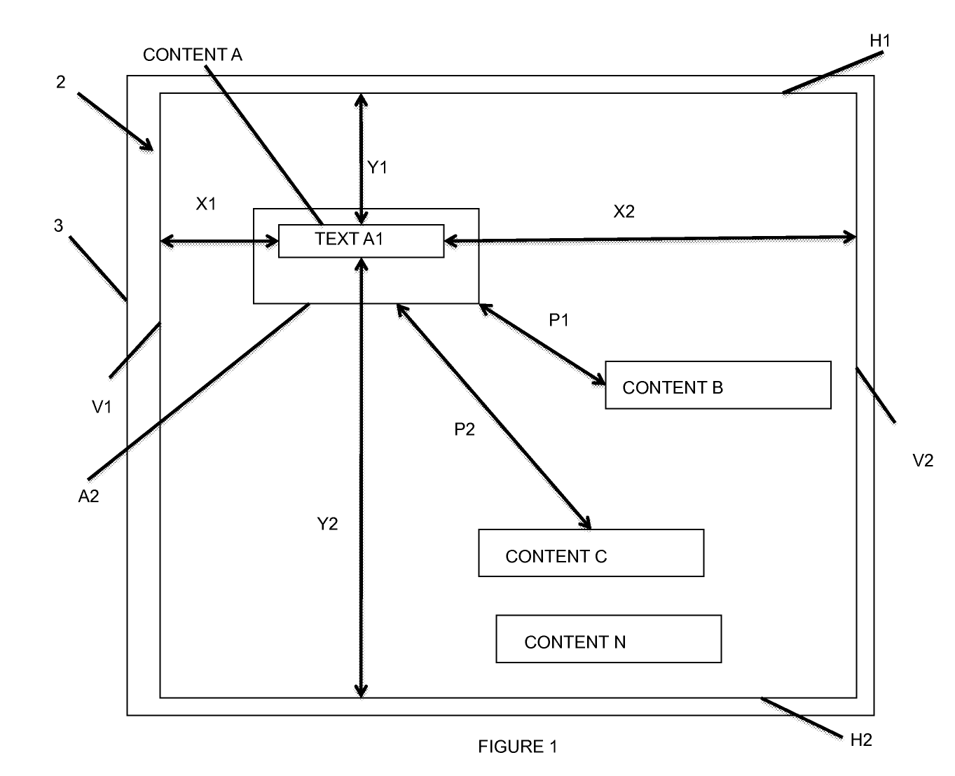

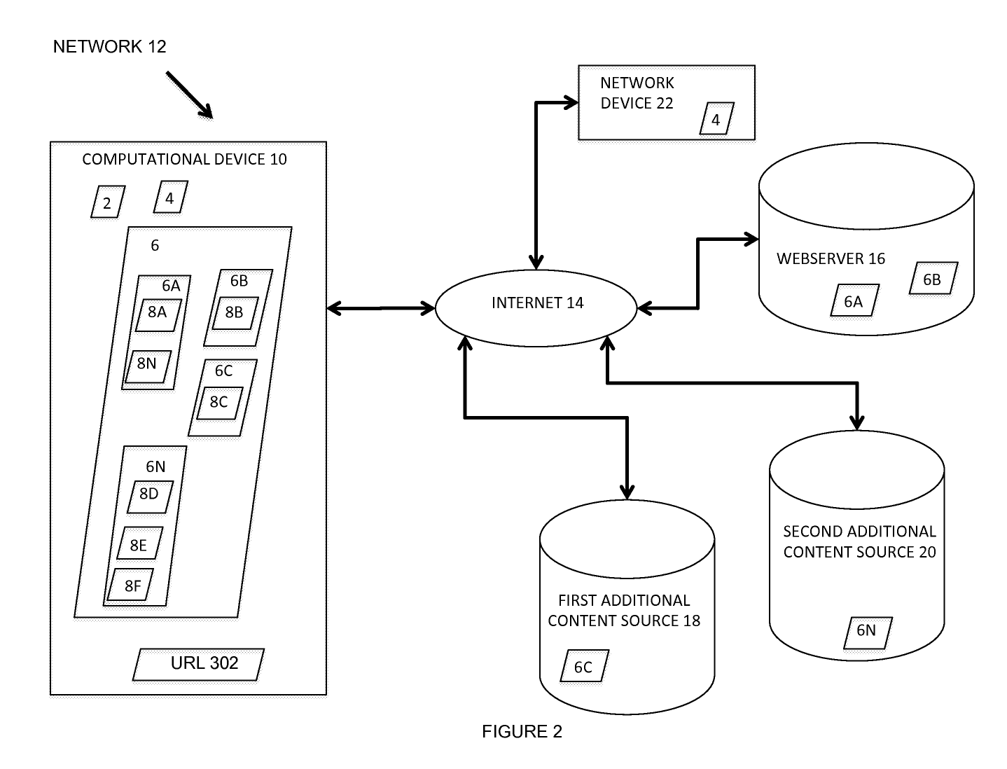

Referring now generally to the Figures, and particularly to FIG. 1 and FIG. 2, FIG. 1 is an illustration of a visually rendered webpage 2 (hereinafter, “webpage” 2) displayed on a video screen 3 as derived by a web browser 4 from a webpage code 6. The exemplary rendered webpage 2 presents a plurality of visually rendered content elements, including at least four visually rendered content elements A, B, C & N. A first visually rendered content element A (hereinafter, “the first rendered element” A) includes a first visually rendered text element A1 (hereinafter, “the first rendered text element” A1) displayed within a first visually rendered content background A2 (hereinafter, “the first rendered background” A2).

The first element A is positioned within the rendered webpage 2 as measured by (a.) two x-axis parameters X1 & X2 each measured from the first element A to the closer of one of two separate vertical web page edges V1 & V2 of the webpage 2, and (b.) two y-axis parameters Y1 & Y2 each measured from the first element to the closer of one of two separate horizontal web page edges H1 & H2 of the webpage 2. A first proximity parameter P1 indicates a relative proximity within the webpage between the first rendered element A and a second visually rendered content element B (hereinafter, “the second rendered element B”), and a second proximity parameter P2 indicates a relative proximity within the webpage between the first rendered element A and a third visually rendered content element C (hereinafter, “third rendered element C”).

There may be one or more additionally visually rendered elements N (hereinafter, “Nth rendered element N”).

Referring now generally to the Figures, and particularly to FIG. 2, FIG. 2 is a network block diagram that illustrates the webpage code 6 comprising a plurality of webpage content 6A-6N and webpage content descriptors 8A-8N as stored within a computational device 10 and elsewhere within an electronic communications network 12. FIG. 2 presents the electronic communications network 12 (hereinafter, “the network” 12) as further comprising and bi-directionally communicatively the computational device 10, the Internet 14, a webserver 16, a first additional content source 18, a second additional content server 20 and a network device 22. The network 2 may optionally include additional computer networks or telephony networks (not shown) bi-directionally communicatively coupled with the Internet 14.

The computational device 10 includes the web browser 4 that may, as referred to in the discussion herein of FIG. 1, derive and generate the webpage 2 from the webpage code 6 on the display screen 3 of the computational device 10. The webpage code 6 preferably includes the plurality of webpage content 6A-6N received via the network 12, wherein each webpage content 6A-6N may include one or more webpage content descriptors 8A-8N. A first webpage content 6A and an individuated second webpage content 6B are received by the computational device 10 from the webserver 16. A third webpage content 6C is received by the computational device 10 from the first additional content source 18. One or more, preferably unique, webpage content 6N is received by the computational device 10 from the second additional content source 20.

Each webpage content descriptor 8A-8N as comprised within an individual webpage content 6A-6N includes preferably unique software code accessed by the web browser 4 in the course of dynamically visually rendering one or more corresponding webpage elements A-N. For example, a first content descriptor 8A provided within the first webpage content 6A comprises instructions and information accessed by the web browser 4 in determining how to dynamically visually render the first rendered element A. However, additional information and instructions included elsewhere in the webpage code 6 may affect a final determination of the web browser 4 in how to instruct the computational device 10 and/or the network device 22 to initially visually render the first rendered element A within the webpage 2. In other words, an analysis of the software code of the first content descriptor 8A in isolation from a remainder of the webpage code 6 can not insure that all instructions and information used by the web browser 4 in directing an actual dynamic rendering of the first rendered element A by the computational device 10 and/or the network device 22 will be evident or applied.

Furthermore, a second content descriptor 8B provided within the second webpage content 6B comprises additional instructions and information accessed by the web browser 4 in determining how to dynamically visually render the second rendered element B. However, other information and instructions included elsewhere in the webpage code 6 may affect a final determination of the web browser 4 in how to instruct the computational device 10 and/or the network device 22 to initially visually render the second rendered element B within the webpage 2.

In addition, a third content descriptor 8C provided within the third webpage content 6C comprises additional instructions and information accessed by the web browser 4 in determining how to dynamically visually render the third rendered element C. However, yet other information and instructions included elsewhere in the webpage code 6 may affect a final determination of the web browser 4 in how to instruct the computational device 10 and/or the network device 22 to initially visually render the third rendered element C within the webpage 2.

Still additionally, one or more Nth content descriptors 8N, each preferably provided within individual and separate Nth webpage content 6N, comprises additional instructions and information accessed by the web browser 4 in determining how to individually dynamically visually render one or more separate rendered elements N. However, even other information and instructions included elsewhere in the webpage code 6 may affect a final determination of the web browser 4 in how to instruct the computational device 10 and/or the network device 22 to initially visually render each Nth rendered element N within the webpage 2.

The computational device 10 may bi-directionally communicate and transfer data with the webserver 16, the first additional content source 18, the second additional content server 20 and/or the network device 22 by suitable electronic communications messaging protocols and methods known in the art including, but not limited to, Simple Object Access Protocol, Representational State Transfer, and/or a web service adapted to conform with the architecture and structure of the World Wide Web.

It is understood that the computational device 10, the webserver 16, the first additional content source 18, the second additional content server 20 and/or the network device 22 may be or comprise a bundled computer software and hardware product, such as (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE 6™ cellular telephone as marketed by Apple, Inc. of Cupertino, Calif.; and/or (g.) other suitable computational system or electronic communications device and product known in the art.

It is noted that the system memory 10H stores various data structures and values, such as integer count values M1 & M2, C1 & C2, time delay values Ts, Td1 & Td2, archived representations REP.001-REP.N and archived advertisements AD.001-AD.N

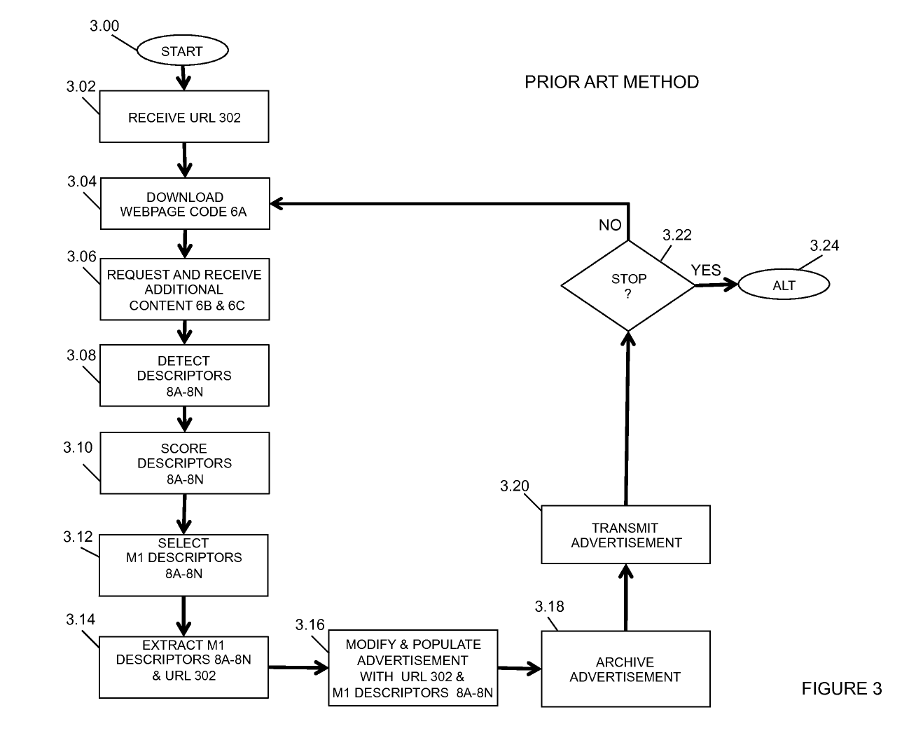

Referring now generally to the FIG. 3 is flowchart of a prior art process of the computational device 10 wherein one or more content descriptors 8A-8N are automatically extracted from the webpage code 6 by a prior art software 300.SW and the content descriptors 8A-8N, and/or aspects thereof, are then inserted into an advertisement document AD.001-AD.N as directed by the prior art content selection software 300.SW.

It is understood that the invented method applies and is compatible with portions of aspects of prior art methods of automatic advertisement generation to include steps and aspects disclosed within U.S. Pat. No. 8,417,568 titled “Generation of contextual image-containing advertisements” and issued on 9 Apr. 2013 (Inventors, Nong, S. et al.); US Patent Application Publication No. 20140122232 titled “Dynamic advertising” and published on 1 May 2014 (Inventors, Press, J. M., et al.); US Patent Application Publication No. 20120030014 titled “Automatic Ad Creative Generation” published on 2 Feb. 2012 (Inventors Brunsman, L. J.); US Patent Application Publication No. 20090157609 titled “Analyzing images to derive supplemental web page layout characteristics” published on 18 Jun. 2009 (Inventors: Phan, T. and Shriwas, R.); US Patent Application Publication No. 20090187481 titled “Automatic generation of electronic advertising messages” and published on 23 Jul. 2009 (Inventors: Bonzi, J. R. et al.); US Patent Application Publication No. 20100306063 “Method and Apparatus for Generating Advertisement” published on 2 Dec. 2010; Foreign Patent Application Publication No. WO2010119262, titled “Apparatus and method for generating advertisements” published on 16 Dec. 2010 (Inventors: Pampapathi, R. et al.).

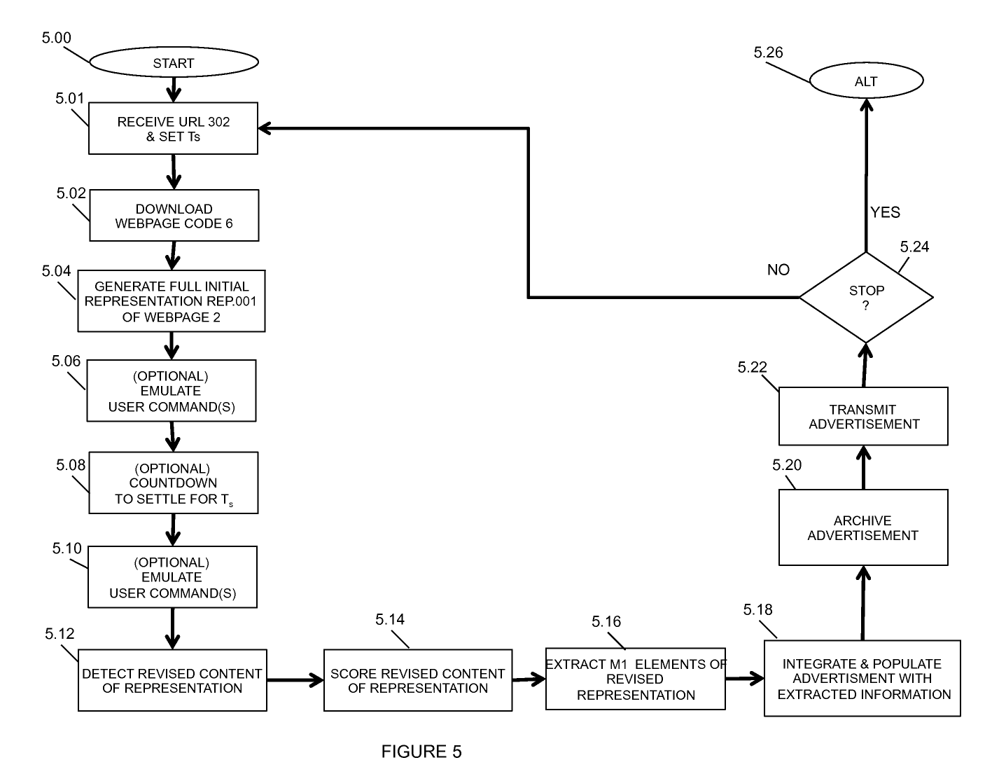

The prior art content selection software 300.SW (hereinafter, “selection software 300.SW”) includes one or more modules 304.SW-310.SW that may be applied in whole or in part within the invented method and as described in relation to steps of FIG. 5 through 8.

In step 3.00 a user directs the computation device 10 to launch the selection software 300.SW and in step 3.02 the computational device 10 receives an exemplary universal resource locator 302 (hereinafter, “URL 302”) for use in generation of a completed first exemplary advertisement document AD.001 (hereinafter, “the first advertisement” AD.001).

In step 3.04 the computational device 10 applies the received URL 302 to locate and download the webpage content 6A from the webserver 16 and the first webpage content 6A is provided to the prior art web browser 4. In optional step 3.06 the computational device 10 requests and receives additional webpage content 6B, 6C & 6N from additional sources 18 & 20 via the network 12 as directed by the prior art web browser 4 and/or the selection software 300.SW as a consequence of an analysis of the first descriptor of the first webpage content 6A received by the computational device 10. In step 3.08 the computational device 10 applies a prior art content detection module 304.SW to analyze the webpage code 6 containing and formed with the webpage content 6A, 6B, 6C & 6N received in step 3.04 and optional step 3.06.

The computational device 10 in step 3.10 then applies a content prominence scoring module 306.SW of the software 300.SW to assign individual relative content prominence scores S1-SN to one, more than one, or all webpage content 6A, 6B, 6C & 6N detected in step 3.08. In one embodiment of the prior art prominence scoring module 306.SW, a prior art scoring method various aspects of each webpage content 6A, 6B, 6C & 6N detected in step 3.08 are analyzed to generate the individual content prominence score S1-SN for each content descriptor 8A-8N comprised within a detected webpage content 6A, 6B, 6C & 6N.

Aspects of the selected webpage content 6A, 6B, 6C & 6N and/or the content descriptors 8A-8N may be evaluated and applied to generate a relative content prominence score S1-SN in the prior art technique of step 3.10 may from the webpage code 6, to include (a.) a specified element size value of a text and/or an image feature of a rendered element A, B, C & N; (b.) a specified font size value of a text feature of a rendered element A, B, C & N; (c.) a specified position-on-screen parameter of a rendered element A, B, C & N; (d.) a clustering aspect score of a rendered element A, B, C & N, wherein an indicated position of a rendered element A, B, C & N as indicated by the webpage code 6 relative to other scored rendered elements A, B, C & N as indicated by the webpage code 6 is scored; and/or (e.) a contrast score derived from a specified brightness value of a textual or image feature of a rendered element A, B, C & N in comparison with a specified brightness value of an associated background brightness value.

An exemplary application of the content scoring module 304.SW of step 3.10 will now be described in reference to a selection of the first descriptor 8A for generation of a first relative content prominence score S1 of the first rendered element A. it is understood that the same method of step 3.10 may optionally also additionally or applied in the alternative to each webpage content 6A-6N and/or each additional descriptor 8B-8N as detected in step 3.08 to generate additional individual content prominence scores S2-SN.

The first content prominence score S1 may be a summation of one or more values derived from information contained within the first descriptor 8A and included in the group consisting of (a.) a first element size value of a text and/or an image feature of the first rendered element A; (b.) a first font size value of a text feature of the first rendered element A; (c.) a first position-on-screen score value of the first rendered element A; (d.) a first clustering aspect score of the first rendered element A, wherein an indicated position of the first rendered element A as indicated by the webpage code 6 relative to other detected and/or scored rendered elements B, C & N as indicated by the webpage code 6 is scored; and/or (e.) a first contrast score derived from a brightness value of a textual or image feature of the first rendered element A in comparison with a brightness value of the associated first content background A2.

It is understood that in the prior art steps 3.08 and 3.10 may alternatively or optionally be applied within a loop wherein each detected descriptor 8A-8N or webpage content 6A-6N is serially detected in an execution of step 3.08 and then scored in an execution of step 3.10 until all detected webpage content 6A-6N and/or descriptors 8A-8N have been detected and scored by generation of a derived associated content prominence score S2-SN.

In prior art step 3.12 a pre-specified number of M webpage content 6A-6N and/or descriptors 8A-8N are selected on the basis of preference indicated by the content prominence scores S1-SN generated in step 3.10. In prior art step 3.14 each webpage content 6A-6N and/or descriptor 8A-8N selected in step 3.12 extracted from the webpage content 6 by a content extraction module 308.SW of the selection software 300.SW. The webpage content 6A-6N and/or descriptors 8A-8N extracted in step 3.14 are then at least partially integrated into the first advertisement AD.001 in step 3.16 by a content integration module 3.10 of the selection software 300.SW. It is understood that the first advertisement includes formatting, contrast and coloring instructions and information that is provided prior to step 3.16, webpage content 6A-6N and/or from descriptors 8A-8N extracted in step 3.14.

The first advertisement AD.001 may then be archived in the computational device 10 or elsewhere in the network 12, and optionally transmitted from the computational device 10 to the network 12. For example, the first advertisement AD.001 may be communicated from the computational device 10 to the network device 22 and rendered by the web browser 4 at the network device 22.

It is evident from an analysis of the steps and method of FIG. 3 that the prior art fails to optimally evaluate, score and select rendered elements A-N by the visual aspects and qualities presented on the video display screen 3 of the rendered elements as would be visually perceived by a human viewer in an initial time period of rendering of the webpage 2, for example, within the first ten seconds or thirty seconds of an initiation by the web browser 4 of such a rendering. In another aspect, the prior art fails to optimally analyze effect of the instructions and information included in the totality of the webpage code 6 is simulating an actual initial rendering of the webpage 2 in order to more optimally evaluate the relative visual prominence of the rendered elements A-N as would be dynamically presented in an actual initial rendering of the webpage 2.

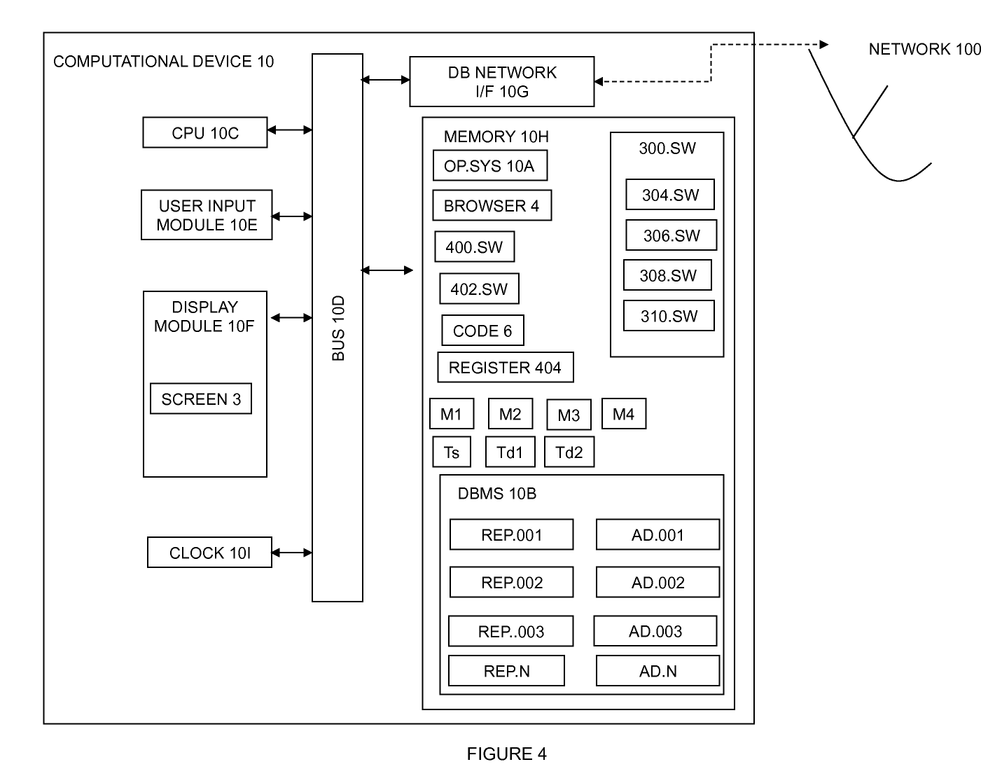

Referring now generally to the Figures, and particularly to FIG. 4, FIG. 4 is a block diagram of the computational device 10 of FIG. 2.

A computational device operating system software OP.SYS 10A of the computational device 10 may be selected from freely available, open source and/or commercially available operating system software, to include but not limited to a LINUX™ or UNIX™ or derivative operating system, such as the DEBIAN™ operating system software as provided by Software in the Public Interest, Inc. of Indianapolis, Ind.; a WINDOWS XP™, VISTA™ or WINDOWS 7™ operating system as marketed by Microsoft Corporation of Redmond, Wash.; or the MAC OS X operating system or iPhone G4 OS™ as marketed by Apple, Inc. of Cupertino, Calif.

The computational device 10 preferably comprises a database management software, i.e. computational device DBMS 10B. The computational device DBMS 10B may be or comprise an object oriented database management system (“OODBMS”) and/or a relational database management system (“RDBMS”), and one or more databases DBS.1-DBS.N may be or comprise an object oriented database and/or a relational database. More particularly, the computational device DBMS 10B may be or comprise one or more prior art database management systems including, but not limited to, a CASSANDRA™ database management system licensed by the Apache Software Foundation of Forest Hill, Md.; an ORACLE DATABASE™ database management system marketed by Oracle Corporation, of Redwood City, Calif.; an MQSERIES™ database management system marketed by SyBase, Inc. of Dublin, Calif.; a Database 2™, also known as DB2™, relational database management system as marketed by IBM Corporation of Armonk, N.Y.; a Microsoft SQL Server™ relational database management system as marketed by Microsoft Corporation of Redmond, Wash.; MySQL™ as marketed by Oracle Corporation of Redwood City, Calif.; and a MONGODB™ as marketed by MongoDB, Inc. of New York City, USA; and the POSTGRESQL™ open source object-relational database management system.

The computational device 10 further includes a central processing unit 10C (“CPU” 10C) that is bi-directionally communicatively coupled by an internal communications bus 10D with (a.) an optional user input module 10E that accepts information and commands input by a user, (b.) a video display module 10F that includes the video screen 3 visually renders information, e.g., the webpage 2, via the video display screen 3, (c.) a network interface 10G that bi-directionally communicatively couples computational device 10 with the network 12, (d.) and a system memory 10H.

An invented software 400.SW is stored within the system memory 10H. The invented software 400.SW is optimally adapted to direct the computational device 10 to perform some or all of the elements, steps and aspects of the prior art method of FIG. 3 and/or some or all of the elements, steps and aspects of the invented method and the methods of FIGS. 5 through 8.

The system memory 10H further includes a copy of the web browser 4 and a headless browser 402.SW. The web browser 4 may be a currently available headless web browser software, such as a GOOGLE CHROME™ web browser software marketed by Google, Inc. of Mountain View, Calif.; OPERA™ web browser software marketed by Opera Software of Oslo, Norway; a SAFARI™ web browser software marketed by Apple, Inc. of Cupertino, Calif.; or other suitable web browser software known in the art. The headless browser 402.SW may be a currently available headless web browser software, such as a PHANTOMJS™ headless web browser available from the website www.phantomjs.org, ZOMBIEJS™ headless web browser available from the webpage http://zombie.labnotes.org, or other suitable headless web browser software known in the art.

Further optionally contained within the computational device DBMS 10B as stored by the system memory 10H of the computational device 10 are optionally a plurality of archived advertisements AD.001-AD.N and a plurality webpage representations REP.001-REP.N.

Referring now generally to the Figures and particularly to FIG. 5, FIG. 5 is a flowchart of an aspect of the invented method whereby the computational device 10 populates an exemplary second advertisement AD.002 from an analysis of a first representation REP.001 of the webpage code 6 as generated by the invented software 400.SW.

In step 5.00 the invented software 400.SW is launched by the user.

In step 5.01 receives the URL 302 preferably from the user via the user input module 10E and optionally initializes a settling time Ts is preferably to a value within a range of from one second to ten seconds and more preferably in range of two seconds plus or minus two tenths of a second.

In step 5.02 the computational device 10 contacts the webserver 16 and initiates a downloading of the webpage code 6 from the webserver 16 and optionally additional sources 18 & 20. It is understood that the content descriptors 8A-8N are received by the computational device 10 via the network 12 in step 5.02 for later integration into the first representation REP.001.

In step 5.04 the invented software 400.SW directs the computational device 10, by means of the headless browser 402.SW, to instantiate the first representation REP.001 of the designated webpage 2. The first representation REP.001 is initially generated in step 5.04 by the headless browser 402.SW to include the instructions and information to be provided to the display module 1 OF to visually initially render the webpage 2 via the display screen 3, including the content descriptors 8A-8N. The headless browser 402.SW progressively modifies the received webpage code 6 in a dynamic generation of the first representation REP.001, wherein software code content of the first representation REP.001, including the webpage code 6 as initially received by the computational device 10 in step 5.02, is revised in accordance with a dynamic simulation by the headless browser 402.SW of a rendering of the webpage 2 in accordance with an execution of the full complement of instructions and information of the webpage code 6 that would be applied by the web browser 4 in generating and providing instructions and information to the display module 10F to render the webpage 2. This revision of the software code of the first representation REP.001 may continue from step 5.04 through and including step 5.10

It is particularly understood that in steps 5.04 through 5.10 one or more content descriptors 8A-8N as stored in the first representation REP.001 may be progressively revised once or more by the operation of the headless browser 402.SW on the webpage code as maintained in evolution within the first representation REP.001.

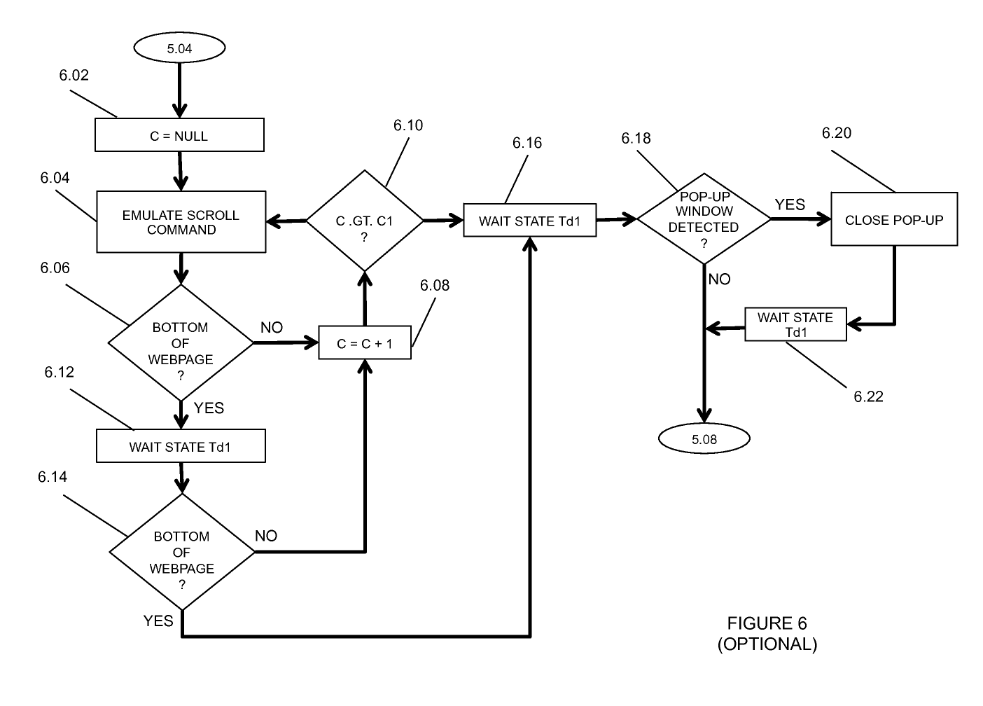

In optional step 5.6 the computational device 10 emulates user inputs, which process may include, but is not limited to, the emulation of scroll down commands, pop-up window closure detailed in FIG. 6.

In step 5.08 the computational device 10 allows the instantiation of the first representation REP.001 to settle for the initialized settling time Ts, wherein the real time clock 10I of the first computational device 10 is applied to counted down an settling time counter 404 as initialized to a count equivalent to a impose count down time value of the initialized settling time Ts.

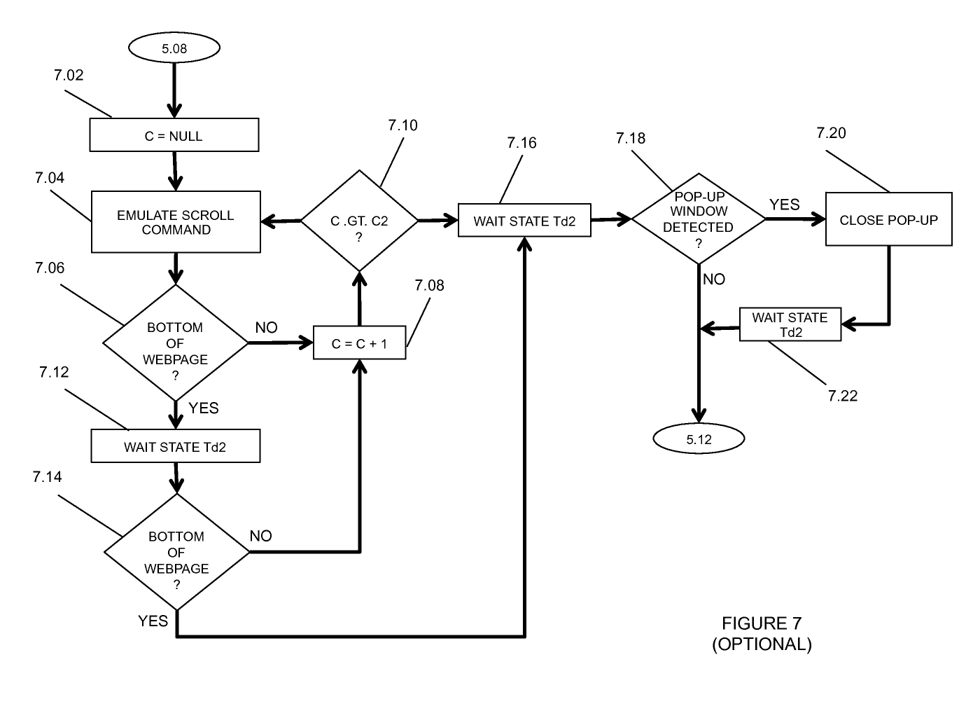

In optional step 5.10 the computational device 10 emulates human viewer inputs, which may include, but is not limited to, the emulation of scroll down commands, pop-up window closure and an additional settling time imposition detailed in FIG. 7.

In step 5.12 the invented software 400.SW applies the prior art detection software module 304.SW to detect the revised webpage content 6A-6N contained within the first representation REP.001. In step 5.14 invented software 400.SW applies the prior art scoring software module 306.SW to score the revised webpage content 6A-6N contained within the first representation REP.001. In step 5.16 the invented software 400.SW applies the prior art extraction software module 308.SW to extract M instances of revised webpage content 6A-6N contained within the first representation REP.001. In step 5.18 the invented software 400.SW applies the prior art integration software module 310.SW to integrate the M1 instances of revised webpage content 6A-6N extracted from the first representation REP.001 in previous step 5.16 to populate the second advertisement AD.002.

In step 5.20 the invented software 400.SW directs the computational device 10 archives the designated advertisement AD.001 within the system memory 10H of the computational device 10. In step 5.22 the computational device 10 transmits the designated second advertisement AD.002 via the network 12. In step 5.24 the computational device 10 determines whether to terminate the loop of steps 5.01 through 5.22. When the determination of step 5.22 is negative, the computational device 10 returns to step 5.01, wherein the computational device 10 downloads an alternate webpage data 6 re-executes the loop of steps 5.01 through 5.22 as instructed by a user or an automated process. In the alternative, when the determination in step 5.22 is positive, the computational device 10 advances to step 5.24 and to perform one or more alternate processes.

Referring now generally to the Figures and particularly to FIG. 6, FIG. 6 is an optional additional process of step 5.06 of the invented method as described in FIG. 5. In step 6.02 the computational device 10 sets a loop counter to a null value and in step 6.04 the headless browser 402.SW emulates a the effect of receipt of a user-issued scroll command upon the state of the first representation REP.001. In step 6.06 the computational device 10 determines whether the first representation REP.001 appears to is simulating a rendering of the bottom of the webpage 2. When the first representation REP.001 is not determined by the computational device 10 in step 6.06 to be simulating a rendering of the bottom of the webpage 2, the computational device 10 proceeds from step 6.06 to step 6.08 and to increase the loop counter C. The computational device 10 next checks to see if the loop counter C has exceed a first loop value C1, and if the loop counter C does not exceed the first loop value C1, the computational device 10 proceeds back to step 6.04 and to simulate an effect upon the first representation of and additional emulated page webpage scroll command.

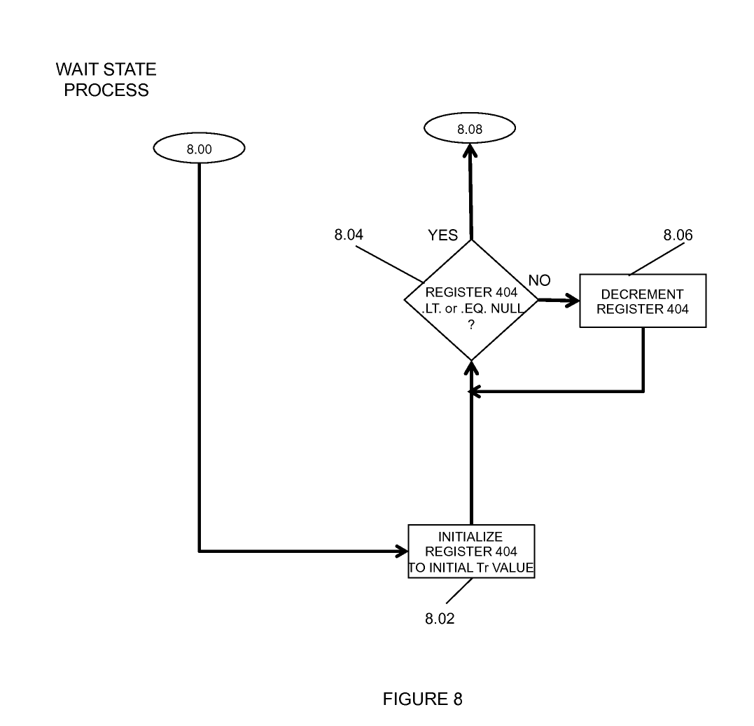

In the alternative, when the first representation REP.001 is determined by the computational device 10 in step 6.06 to be simulating a rendering of the bottom of the webpage 2, the computational device 10 proceeds from step 6.06 to step 6.12 and imposes a wait step by applying a first time value Td1 in the wait process method of FIG. 8. Step 6.12 is applied to enable the headless browser 402.SW and the invented software 400.SW to allow the first representation REP.001 to simulate an evolution of the rendering of the webpage 2 by the web browser 4 as the webpage 2 would be experienced by the human viewer.

After the wait time of the execution of step 6.12 has passed, the computational device 10 again determines in step 6.14 whether the first representation REP.001 appears to is simulating a rendering of the bottom of the webpage 2. When the first representation REP.001 is not determined by the computational device 10 in step 6.14 to be simulating a rendering of the bottom of the webpage 2, the computational device 10 proceeds from step 6.14 to step 6.08 and to increase the loop counter C. The computational device 10 next checks to see if the loop counter C has exceed a first loop value C1, and if the loop counter C does not exceed the first loop value C1, the computational device 10 proceeds back to step 6.04 and to simulate an effect upon the first representation of and additional emulated page webpage scroll command.

In the alternative, when the first representation REP.001 is determined by the computational device 10 in step 6.14 to be simulating a rendering of the bottom of the webpage 2, the computational device 10 proceeds from step 6.14 to step 6.16 and optionally imposes an additional wait step by again applying the first time value Td1, other time value, in the wait process method of FIG. 8.

After the optional and additional wait time of the execution of step 6.16 has passed, the computational device 10 determines in step 6.18 if the first representation REP.001 indicates the presence of a pop-up window process, and the headless browser 402.SW closes any indicated pop-up window representation in step 6.20 by emulation of a receipt of a user-issued pop-up window closure command. The computational device 10 proceeds from step 6.20 to step 6.22 and optionally imposes an additional third wait step by applying the first time value Td1, or other time value, in a third applications of the wait process method of FIG. 8.

The computational device 10 subsequently proceeds from either step 6.18, or from the execution of step 6.22 to step 5.08 of FIG. 5.

Referring now generally to the Figures and particularly to FIG. 7, FIG. 7 is an optional additional process of step 5.10 of the invented method as described in FIG. 5. In step 7.02 sets a loop counter to a null value and in step 7.04 the headless browser 402.SW emulates a the effect of receipt of a user-issued scroll command upon the state of the first representation REP.001. In step 7.06 the computational device 10 determines whether the first representation REP.001 appears to is simulating a rendering of the bottom of the webpage 2. When the first representation REP.001 is not determined by the computational device 10 in step 7.06 to be simulating a rendering of the bottom of the webpage 2, the computational device 10 proceeds from step 7.06 to step 7.08 and to increase the loop counter C. The computational device 10 next checks to see if the loop counter C has exceed a first loop value C1, and if the loop counter C does not exceed the first loop value C1, the computational device 10 proceeds back to step 7.04 and to simulate an effect upon the first representation of and additional emulated page webpage scroll command.

In the alternative, when the first representation REP.001 is determined by the computational device 10 in step 7.06 to be simulating a rendering of the bottom of the webpage 2, the computational device 10 proceeds from step 7.06 to step 7.12 and imposes a wait step by applying a second time value Td2 in the wait process method of FIG. 8. Step 7.12 is applied to enable the headless browser 402.SW and the invented software 400.SW to allow the first representation REP.001 to simulate an evolution of the rendering of the webpage 2 by the web browser 4 as the webpage 2 would be experienced by the human viewer.

After the wait time of the execution of step 7.12 has passed, the computational device 10 again determines in step 7.14 whether the first representation REP.001 appears to is simulating a rendering of the bottom of the webpage 2. When the first representation REP.001 is not determined by the computational device 10 in step 7.14 to be simulating a rendering of the bottom of the webpage 2, the computational device 10 proceeds from step 7.14 to step 7.08 and to increase the loop counter C. The computational device 10 next checks to see if the loop counter C has exceed a first loop value C1, and if the loop counter C does not exceed the first loop value C1, the computational device 10 proceeds back to step 7.04 and to simulate an effect upon the first representation of and additional emulated page webpage scroll command.

In the alternative, when the first representation REP.001 is determined by the computational device 10 in step 7.014 to be simulating a rendering of the bottom of the webpage 2, the computational device 10 proceeds from step 7.14 to step 7.16 and optionally imposes an additional wait step by again applying the second time value Td2, or other time value, in the wait process method of FIG. 8.

After the optional and additional wait time of the execution of step 7.16 has passed, the computational device 10 determines in step 7.18 if the first representation REP.001 indicates the presence of a pop-up window process, and the headless browser 402.SW closes any indicated pop-up window representation in step 7.20 by emulation of a receipt of a user-issued pop-up window closure command. The computational device 10 proceeds from step 7.20 to step 7.22 and optionally imposes an additional third wait step by yet again applying the second time value Td2, or other time value, in a third applications of the wait process method of FIG. 8.

The computational device 10 subsequently proceeds from either step 7.18, or from the execution of step 7.22 to step 5.12 of FIG. 5.

Referring now generally to the Figures and particularly to FIG. 8, FIG. 8 is a flowchart of a method of inserting a time delay in a wait state as optionally applied in the optional process steps of step 5.08 of FIG. 5, of step 6.12, 6.16 and 6.22 of FIG. 6, and of step 7.12, 7.16 and 7.22 of FIG. 7, wherein the first representation REP.001 of the simulated rendering of the webpage 2 of FIG. 4 is further developed to better simulate a user view of the initially rendered webpage 2. Step 8.00 may thus be embodied as an initiation of an instance of step 5.08, 6.12, 6.16, 6.22, 7.12, 7.16 or 7.22.

In step 8.02 the computational device 10 writes a time delay register value Tr in to a count down register 404. The time delay register value Tr may be the settling time value Ts in an execution of step 5.08 of FIG. 5, or the first time delay value Td1 in an execution of steps 6.12, 6.16 or 6.22 of FIG. 6, or in an execution of step 7.12, 7.16 or 7.22 of FIG. 7. The computational device 10 determines in step 8.04 whether the value held in the count down register 404 has yet been decremented to a null value or a lesser value. The computational device 10 continues to decrement the value held in the count down register 404 by successive executions of step 8.06, until the value held in the count down register 404 is determined to be less than or equal to the null value in a following execution of step 8.04.

The computational device 10 proceeds on to step 8.08 after a determination in step 8.04 that the value held in the count down register 404 has been decremented to a null value or a lesser value. Step 8.00 may thus be embodied as an initiation of an instance of step 5.10, 5.12, 6.14, 6.18, 7.14 or 7.18.

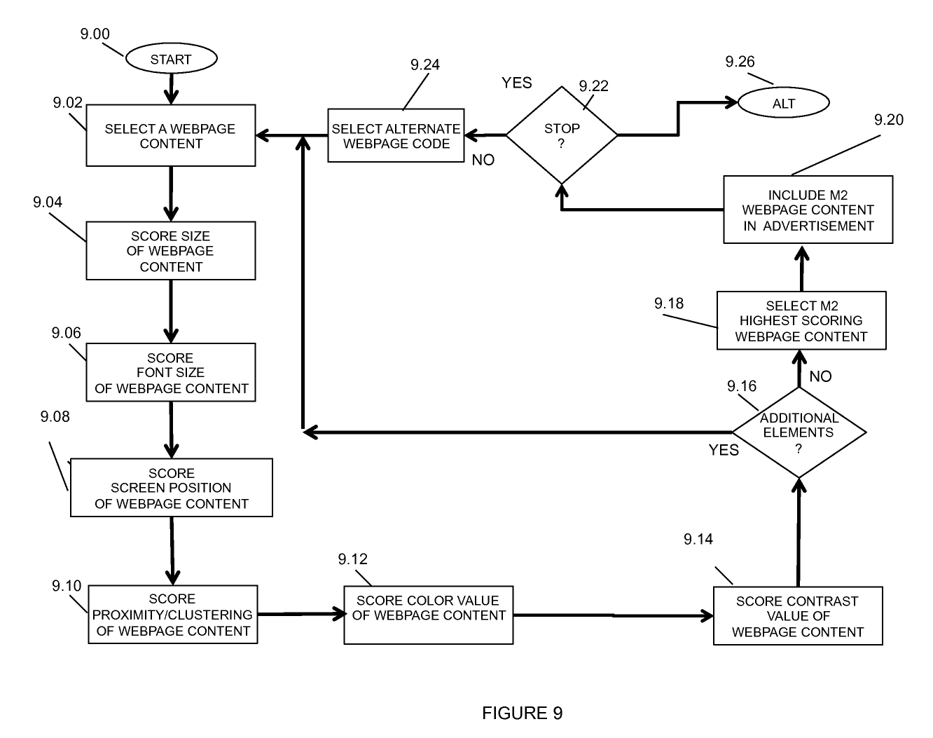

Referring now generally to the Figures and particularly to FIG. 9, FIG. 9 is a flowchart of a further optional aspects of the invented method, whereby the computational device 10 selects, extracts, and scores visual webpage content 6A-6N within the first representation REP.001 as generated by, and revised by interaction with, the headless browser 402.SW. In step 9.02 the computational device 10 selects an individual webpage content 6A-6N for evaluation, calculation and separate assignment of a unique cumulative numerical visual prominence score S1-SN to each webpage content 6A-6N. For the sake of clarity of explanation, the method of FIG. 9 will be discussed in application with the first webpage content 6A in portions of the explanation of FIG. 9, whereas it is understood that the method of FIG. 9 may be applied to each and every webpage content 6A-6N comprised within or derived from the webpage code 6.

The computational device 10 proceeds to step 9.04, wherein the computational device 10 increases a first numerical score S1 (hereinafter, the “first score S1”) of the selected webpage content 6A in relation to an indicated size of the first webpage content 6A. The computational device 10 proceeds to step 9.06, wherein the computational device 10 increases the first score S1 in relation to a detected font size of a textual element of the first webpage content 6A. The computational device 10 proceeds to step 9.08, wherein the computational device 10 increases the first score S1 in relation to an indicated screen position of the first webpage content 6A. The computational device 10 proceeds to step 9.10, wherein the computational device 10 increases the first score S1 in relation to an indicated clustering of the first webpage content 6A with other scored webpage content 6B-6N of the first representation REP.001.

The computational device 10 next increases the first score S1 of the selected webpage content 6A in accordance with the color brightness value determined in step 9.12 and then advances on to step 9.14. The computational device 10 increases the first score S1 of the selected webpage content 6A in accordance with the contrast value determined in step 9.14 and then advances on to step 9.16.

The computational device 10 next determines in step 9.16 whether additional webpage content 6B-6N are present and/or shall be scored through application of the loop 9.02 through 9.16. When the determination in step 9.16 is positive, the computational device 10 returns to step 9.02 and selects additional webpage content 6B-6N of the webpage code 6.

Alternatively, when the determination in step 9.16 is negative, the computational device 10 proceeds to step 9.18. In step 9.18 computational device 10 selects the highest scoring webpage content 6A-6N up to a preset quantity M2 of webpage content 6A-6N for inclusion in an advertisement AD.001-AD.N. In step 9.20 the computational device 10 integrates the preset number M2 of the webpage content 6A-6N associated with the highest scores S1-SN, as selected in step 9.18, within the advertisement AD.002.

In step 9.22 the computational device 10 determines whether to terminate the process of FIG. 9 or to apply the process of FIG. 9 to an selected alternate webpage code (not shown in the Figures). In step 9.24 the computational device 10 selects the alternate webpage code for application in the loop of steps 9.02 through 9.16 and proceeds on to step 9.02 and executes the loop of steps 9.02 through 9.16 on the additional webpage content and/or alternate webpage code selected in step 9.24.

When the computational device 10 determines in step 9.22 to terminate the process of FIG. 9, the computational device 10 proceeds on to execute alternate processes in step 9.26.

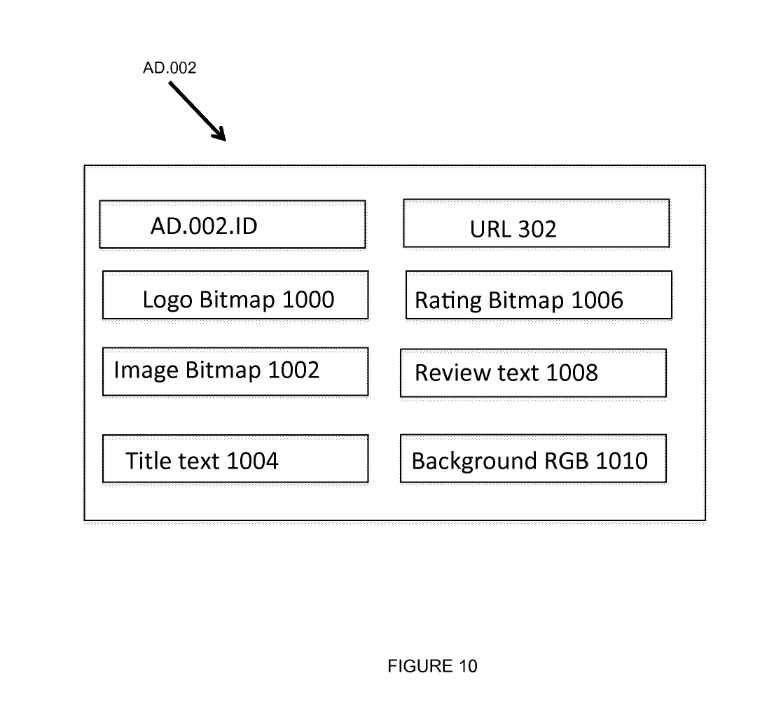

FIG. 10 is a block diagram of the second advertisement AD.002 as derived by the invented method from the webpage code 6 of the first representation REP.001 by various aspects of the methods of FIGS. 5 through 9. The second advertisement. The second advertisement AD.002 includes an advertisement identifier AD.001, the URL 302 of the web code 6, a logo bitmap data 1000 derived from the first representation REP.001, an image bitmap data 1002 derived from the first representation REP.001, a title text 1004 derived from the first representation REP.001, a rating signage bitmap 1006 derived from the first representation REP.001, a review text data 1008 derived from the first representation REP.001, and a background color data 1010 derived from the first representation REP.001.

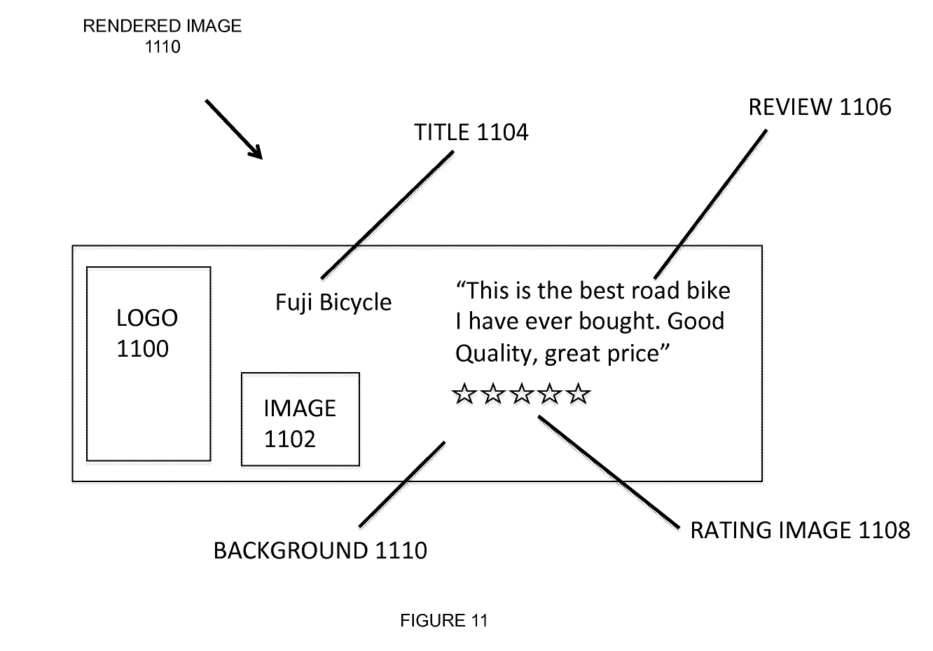

FIG. 11 is an illustration of visual elements 1100-1108 presented within a visually rendered image 1110 of the second advertisement AD.002. The image 1110 is generated by the network device 22 directing the browser 4 to display data 1000-1008 of the second advertisement AD.002.

A logo image 1100 is generated by the browser 4 from the logo bitmap data 1000; a second image 1102 is generated by the browser 4 from the image bitmap data 1002; a title text 1104 is rendered by the browser 4 from a title text data 1004; a rating signage image is rendered by the browser 4 from the rating signage bitmap 1006; a review text image 1108 is rendered by the browser 4 from the review text data 1008; and a background image 1108 is rendered by the browser 4 from the background color data 1010.

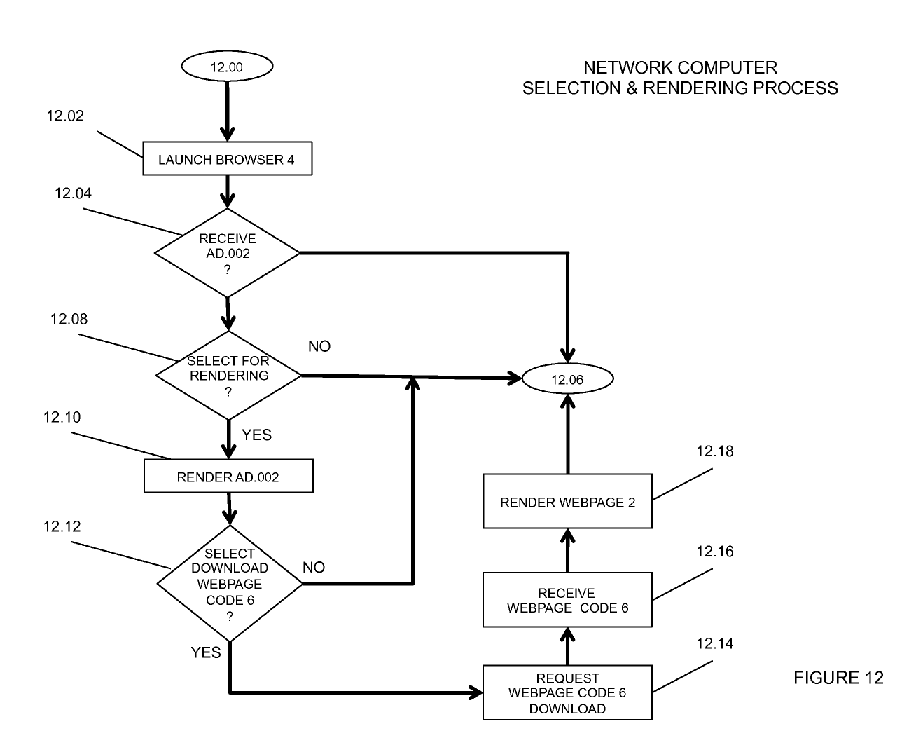

FIG. 12 is a flowchart of operations of the network device of FIG. 2 whereby the advertisement of FIG. 10 renders the display image of FIG. 11. In step 12.02 the network device 22 launches the browser 4 and may receive the advertisements AD.001-AD.N in step 12.04. or alternatively proceed onto other operations in step 12.06. The network device 22 may as directed by a user select a received advertisement for rendering in step 12.08 and then render the selected advertisement in step 12.10.

The network device 22 may as directed by a user select a webpage code via a universal resource locator reference within the advertisement AD.001-AD.N rendered in step 12.12 and then in step 12.14 request the referenced webpage code from the universal resource locator referenced in the rendered advertisement AD.001-AD.N.

In step 12.16 the network device 22 receives the requested webpage code and renders the received webpage code in step 12.18. The network device 22 may proceed from step 12.04 12.12, or 12.18 and to perform other operations.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computational device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

I claim:

1. A computer implemented method of generation of digitized advertisement content by extraction of visual content from a representation of a completed webpage rendering, the method comprising:
a. Receiving a document containing a webpage content, wherein the document is sufficient to enable a web browser to direct a computational device to render an instantiation of a webpage;
b. Generating a representation of a completed visual rendering of the document (“the representation”);
c. Extracting an information from the representation; and
d. Including the information extracted in element c in a resultant digitized advertisement document (“advertisement”), wherein the advertisement is sufficient to enable the web browser to direct a computational device to visually render the information.

2. The method of claim 1, further comprising:
a. Receiving a second document, the second document containing additional web page content sufficient in combination with the previously received document to enable the web browser to generate an expanded representation of the webpage;
b. Generating the expanded representation;
c. Extracting an alternate information from the expanded representation; and
d. Including the alternate information extracted in element c in the advertisement, wherein the advertisement is sufficient to enable the web browser to direct a computational device to visually render the information and the alternate information.

3. The method of claim 1, wherein at least a portion of the webpage content is received from a second source external to the webserver.

4. The method of claim 1, wherein the document is sent in response to a webpage download request.

5. The method of claim 1, wherein a wait time is interposed between an initiation of generating the representation and the extracting the information.

6. The method of claim 1, wherein the information is evaluated according to a qualitative criterion.

7. The method of claim 6, wherein the qualitative criterion comprises a font size indication of the information.

8. The method of claim 6, wherein the qualitative criterion comprises a screen position indication of the information within the representation.

9. The method of claim 6, wherein the qualitative criterion comprises a proximity indication of the information to at least one other display position of another information within the representation.

10. The method of claim 6, wherein the qualitative criterion comprises an indicated brightness value associated with the information.

11. The method of claim 1, wherein the advertisement provides a hyperlink comprising a universal resource locator.

12. The method of claim 1, wherein the advertisement provides a hyperlink to a webserver.

13. A computer implemented method of generation of digitized advertisement content by extraction of visual content from a representation of a completed webpage rendering as affected by emulated user interaction, the method comprising:
a. Receiving a digitized document, wherein the digitized document is sufficient to enable a web browser to direct a computational device to visually render at least a portion of a webpage;
b. Generating a representation of a completed visual rendering of the document (“the representation”);
c. Emulating a first user interaction with the representation to generate a first resultant representation of a visual rendering of the document in accordance with a response of the web browser to the first user interaction with the representation;
d. Extracting an information from the first resultant representation; and
e. Including the information extracted in element c in a resultant digitized advertisement document (“advertisement”), wherein the advertisement is sufficient to enable the web browser to direct a computational device to visually render the information.

14. The method of claim 13, further comprising:
a. Receiving a second document, the second document containing additional information sufficient to enable the web browser to generate an expanded representation of the webpage;
b. Emulating a second user interaction with the expanded representation to generate a second resultant representation of a completed visual rendering of the document and the second document in accordance with a response of the web browser to the second user interaction with the expanded representation;
c. Extracting an alternate information from the second resultant representation; and
d. Including the information extracted in element c in the advertisement.

15. The method of claim 13, wherein the information is received from a second source external to a source of the webpage content.

16. The method of claim 13, wherein the emulated first user interaction is a scrolling command.

17. The method of claim 16, wherein the information is received after the initiation of the emulated scrolling command.

18. The method of claim 16, wherein the information is received from a second source external to the webserver and in response to the instantiation of the emulated scrolling command.

19. The method of claim 13, wherein the emulated first user interaction is a pop up window closure command.

20. The method of claim 13, wherein a wait time is interposed between an initiation of the generation of the representation and the emulation of the first user interaction.
